(19) United States
(12) Patent Application Publication
(10) Pub. No.: US 2004/0005992 A1
(43) Pub. Date: Jan. 8, 2004

(54) Composition and method of use for self-carbonated fabric cleaner and fabric pre-sprays

(76) Inventor: Jeffrey N. Ebberts, Ardmore, OK (US)

Correspondence Address: JAMES F HARVEY III, HARVEY & ASSOCIATES, 3750 WEST MAIN STREET, SUITE 120, NORMAN, OK, 73072, US

(21) Appl. No.: 10/613,673

(22) Filed: Jul. 3, 2003

Related U.S. Application Data
(60) Provisional application No. 60/393,530, filed on Jul. 5, 2002.

(51) Int. Cl. C11D 1/00

(52) U.S. Cl. 510/276; 510/509

(57) ABSTRACT

Carpeting, upholstery, drapery and other textile fibers may cleaned by applying to the fibers, from an application device, an aqueous self-carbonated cleaning solution prepared by mixing an acidic partially-carbonated pre-spray solution having a pH of about 4 with an alkaline partially-carbonated pre-spray solution having a pH of about 10, to provide the self-carbonated cleaning solution with a pH of about 7 and carbon dioxide bubbles. The pre-spray may each be thus effectively used either separately or in combination. The application device may have a valve allowing the operator to control the proportion of acidic and alkaline pre-spray solutions that are used to provide the self-carbonated cleaning solution and to thus selectively adjust the pH of the resulting solution. Both pre-spray solutions may be comprised of the same constituents, namely an acid, a carbonate salt, and a bicarbonate or percarbonate salt, but the specific choices for acid, carbonate salt, and bicarbonate or percarbonate salt may be different between solutions.

### CROSS-REFERENCES TO RELATED APPLICATIONS

This patent application claims the benefit of U.S. Provisional Application No. 60/393,530, filed Jul. 5, 2002, of similar title.

### BACKGROUND OF THE INVENTION

The present invention relates generally to the area of fabric and carpet cleaners, and more particularly, to a novel pre-spray cleaning method and composition for removing contaminants from carpets and other fabrics without harming the colorants and protectants contained therein.

The commercial business of carpet cleaning has evolved to the point that standard procedures have been developed for removing contaminants from carpet or heavy duty fabric used in commercial establishments. Generally, the area to be cleaned is evaluated to determined the degree of soiling present. Areas that are extremely soiled are first given a pre-treatment to remove the really difficult contaminants and condition the area for normal cleaning. Thereafter a standard, overall cleaning operation is performed to remove any residual pre-treatment solution and clean the entire area.

There are many kinds of pre-sprays that are used during pre-treatment to help restore heavily soiled or damaged fabric, which preconditions the fabric prior to normal cleaning. One adverse condition found in carpet that generally requires the use of a pre-spray is the presence of large amounts of soiling agents, such as lard, grease, dirt, and grime, being concentrated in specific areas of a carpet. This condition is usually found in high traffic areas where much of the soiling agents are deposited by foot traffic and spills, such as the carpeted entry to the kitchen area in a busy restaurant. Cleaning such areas has typically required the use of high pH cleaning products, with pH levels as high as 11-13 to remedy the problem. Unfortunately, these products require the use of soaps, detergents, surfactants, ammonia and other de-greasers as a pre-spray component for raising the pH to the desired level in order to effect any measure of cleaning, but these additives also have their adverse effects, such as creating a further buildup of such components within the carpet.

Another such condition, commonly referred to as “brown out”, occurs in carpet and is caused by soapy and alkaline residues in the carpet fiber. These residues are typically left by professional carpet cleaners consist of soaps, detergents, surfactants, ammonia, and de-greasers that are not adequately removed from the carpet fabric during the cleaning process. The fabric takes on a dull look, sometimes turning brown or gray as the soaps, detergents, and other cleaning chemicals discolor and attract additional dirt that further contaminates the fabric. Because of the concentrated nature of these residual cleaners remaining in the carpet, these dull, graying effects can be extremely difficult to fix. Pre-sprays with low pH in the range of from 2 to 4 have typically been used to remedy brown-out. However, such pre-spray products have their own set of hazards and require the use of various acids which can react adversely with the carpet dye to cause a change in color in the carpet. The acid may also destroy any carpet protectants that might be therein.

Once the pre-treatment of the carpet or fabric has been completed, then the carpet or fabric is cleaned by conventional cleaning compounds, in particular, self-carbonated cleaners. These cleaning preparations generally exhibit a neutral or near neutral pH. Various self-carbonating cleaning solutions have been proposed in the prior art. Examples of such self-carbonating cleaning solutions are disclosed in U.S. Pat. No. 4,219,333, issued to Harris on Aug. 26, 1980; U.S. Pat. No. 4,244,468, issued to Harris on Set. 14, 1993; U.S. Pat. No. 5,624,465, issued to Harris on Apr. 29, 1997; U.S. Pat. No. 5,718,629, issued to Harris on Feb. 7, 1998; and U.S. Pat. No. 6,126,697, issued to Ebberts on Oct. 3, 2000. Some of the self-carbonating cleaning solutions disclosed in this prior art, and in particular the patents to Harris, may contain additional surfactants, detergents, and other ingredients to increase the cleaning effect. Self-carbonation is generally achieved either by mixing an alkali and an acid in solution within a pressurized container to maintain the resulting carbon dioxide generated therefrom in solution or by holding an alkaline solution and an acidic solution in separate containers and mixing them immediately before application to an area to be cleaned.

Numerous application devices have been disclosed for separately holding the acid solution and the alkaline solution in separate containers and then mixing these solutions immediately before application to a carpet or fabric; the solutions are formulated to combine to produce a generally neutral self-carbonating cleaning preparation that produces carbon dioxide bubbles. These application devices may also contain heating means for pre-heating the component solutions, either separately or after they have been mixed, to further increase the cleaning effect. One common drawback of these devices is the necessity to remove the tanks holding the component solutions, purging the lines, and replacing these tanks with tanks containing pre-spray solutions. Sometimes separate devices are employed, one for the self-carbonating cleaning solution components and one for the pre-spray solution; however, this approach results in the necessity of simultaneously operating multiple devices at the job site, the increased probability that the wrong device will be used for either pre-spray or cleaning operations, increased maintenance costs for multiple devices, and increased power requirements at the job site.

As can be seen, there is a need for a cleaning composition, system, and method that eliminates the necessity for multiple application devices and also for a pre-spray composition that avoids the problems of brown-out and at the same time addresses the problems of disparate pH requirements for various pre-spray applications.

### SUMMARY OF THE INVENTION

The invention provides an inventive and non-obvious method, system, and cleaning solution for use in cleaning textile fibers, namely, carpets, upholstery, curtains, and the like. The invention provides a self-carbonated cleaning solution that consists of a mixture of acidic first component solution containing an acid, a carbonate, and a bicarbonate or percarbonate, and an alkaline second component solution containing an acid, a carbonate, and a bicarbonate or percarbonate. Each of the component solutions may contain the same constituents as the self-carbonated cleaning solution but with differing pH values. Each of the component solutions may individually be used as a pre-spray for pre-treatment of different types of soiled surfaces. The invention also provides a system for selective application of the acidic first component solution, the alkaline second component solution, and the neutral self-carbonating cleaning solution, as necessary. The invention also provides an innovative method for cleaning fabrics in which a single system may be used be a single operator or multiple operators to pre-treat problem areas of textile fabrics.

In one aspect of the invention, a self-carbonated cleaning solution may be prepared by combining an alkaline cleaning composition having a pH in the range of 9 to 11, and preferably about 10, and an acidic solution having a pH of around 4 to produce the self-carbonated cleaning solution having a pH of around 7, the alkaline cleaning composition and the acidic cleaning composition each containing a mixtures of alkaline constituents, i.e. carbonates, and bicarbonates or percarbonates, and acidic constituents.

In another aspect of the invention, an acidic partially carbonated pre-spray solution having a pH between about 3 to 5, and preferably about 4, may be prepared by combining a mixture of alkaline constituents, i.e. carbonates, and bicarbonates or percarbonates, and acidic constituents. The acidic partially carbonated pre-spray solution may be used for pre-treatment of brown-out conditions caused by residues of detergents and alkaline cleaners left in a textile fabric and also for the acidic cleaning composition in the production of the self-carbonated cleaning solution.

In another aspect of the invention, an alkaline partially-carbonated pre-spray solution having a pH of about in the range of 9 to 11, and preferably about 10, may be prepared by combining a mixture of alkaline constituents, i.e. carbonates, and bicarbonates or percarbonates, and acidic constituents. The alkaline partially-carbonated pre-spray solution may be used for pre-treatment specific areas of fabric having large, concentrated amounts of soiling agents, such as lard, grease, dirt, and grime, and also for the alkaline cleaning composition in the production of the self-carbonated cleaning solution.

In another aspect of the invention, an application device is provided that holds the alkaline partially-carbonated pre-spray solution and the acidic partially carbonated pre-spray solution in separate containers and allows the pre-spray solutions to be separately accessed for application without mixing or to be mixed to provide self-carbonated cleaning solution having a pH of around 7, thus permitting both pre-spray and final cleaning solutions to simultaneously be held and maintained by the same cleaning apparatus for use by either a single operator or multiple operators.

These and other features, aspects and advantages of the present invention will become better understood with reference to the following drawings, description and claims.

### BRIEF DESCRIPTION OF THE DRAWINGS

FIG. 1 shows a schematic diagram of a prior art apparatus for applying a cleaning solution to a textile fabric, according to an embodiment of the invention;

FIG. 2 shows a schematic diagram of an embodiment of the mixing means described as a compression tee in FIG. 1; and

FIG. 3 a schematic diagram of another embodiment of the mixing means described as a compression tee in FIG. 1.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims.

The multiple carbonate cleaning solution described in Applicant's U.S. Pat. No. 6,126,697 (“The '697 Patent”), incorporated herein by reference, discloses a multiple carbonate cleaning solution comprised of an aqueous solution made from a solid acid, a carbonate salt, and a bicarbonate or percarbonate salt, having a neutral pH. It should be noted here in passing that the term “bicarbonate or percarbonate salt” as used herein refers to the selection of a single salt from a group of salts having some members that are bicarbonates and some members that are percarbonates. In practice, the aqueous solution may be stored as a first component solution containing the carbonate salt and bicarbonate or percarbonate salt and a second component solution containing the acid. These two solutions, i.e. the alkaline first component solution and the acidic second component solution, may then be combined and applied to a soiled area of textile fabric so that, when the two solutions are combined immediately before application, a carbonating action is produced that assists the cleaning process. The multiple carbonate cleaning solution as described does not require additional detergents, soaps, or surfactants. Applicant's U.S. Pat. No. 6,554,207 (“the '207 Patent”), also incorporated herein by reference, discloses an application device that may hold the first and second components of the multiple carbonate cleaning solution in two separate containers for combination on demand to provide a generally neutral pH, self-carbonating cleaning solution for application to a carpet or fabric by use of a standard spraying wand. The application device described in the '207 Patent was designed to provide the solutions heretofore described.

The invention disclosed herein provides a system, method, and chemical composition in which the two component solutions may themselves be useful as pre-spray solutions for separate application to problem areas of textile fabric, but which can be combined to provide the self-carbonated cleaning solution described in the '697 Patent, or similar compositions. The alkaline first component solution may have a pH of in the range of 9 to 11, and preferably about 10, and the acidic second component solution may have a pH in the range of 3 to 5, and preferably about 4. These two solutions may normally be mixed by directing them to opposed ports of a mixing means in the application device, where they may combine to create a balanced, freshly carbonated cleaning solution with a generally neutral pH of about 7 that may then be applied to a textile fabrics. One benefit of this method is that the multiple carbonate cleaning solution is always be combined immediately before use and is thus freshly carbonated. The component solutions are not required to be stored in pressurized containers since the carbonating action may occur immediately before application when the two solutions are actually mixed.

The invention provides an aqueous cleaning solution comprising two component solutions, one of which is an alkaline pre-spray solution comprising an aqueous mixture of a carbonate salt, a bicarbonate or percarbonate salt, and an acid and the other being an acidic pre-spray solution also comprising an aqueous mixture of a carbonate salt, a bicarbonate or percarbonate salt, and an acid. The prior art teaches the use of separate acid and alkaline component solutions that are brought together to provide carbon dioxide for effervescing action on the object to be cleaned, e.g. carpets or upholstery fibers. The inventive component solutions described herein may each be used for pre-cleaning operations and later combined to provide the desired effervescing action.

A beneficial effect of this system, method, and cleaning composition is that an acid solution with a pH of about 4 can be separately accessed and used in situations that require a low pH pre-spray without necessarily accessing the alkaline pre-spray solution. Conversely, the alkaline pre-spray solution with a pH of about 10 can be separately accessed and used in situations that require a high pH pre-spray without accessing the acidic pre-spray solution. Neither the acid pre-spray solution nor the alkaline pre-spray solution may contain the solvents, soaps, detergents, surfactants, ammonia, un-buffered acids or other undesirable ingredients commonly required by existing cleaning products. Because small quantities of solutions are used, regardless of the cleaning requirement, either solution or the combined solution can be easily and efficiently heated, as each specific situation warrants.

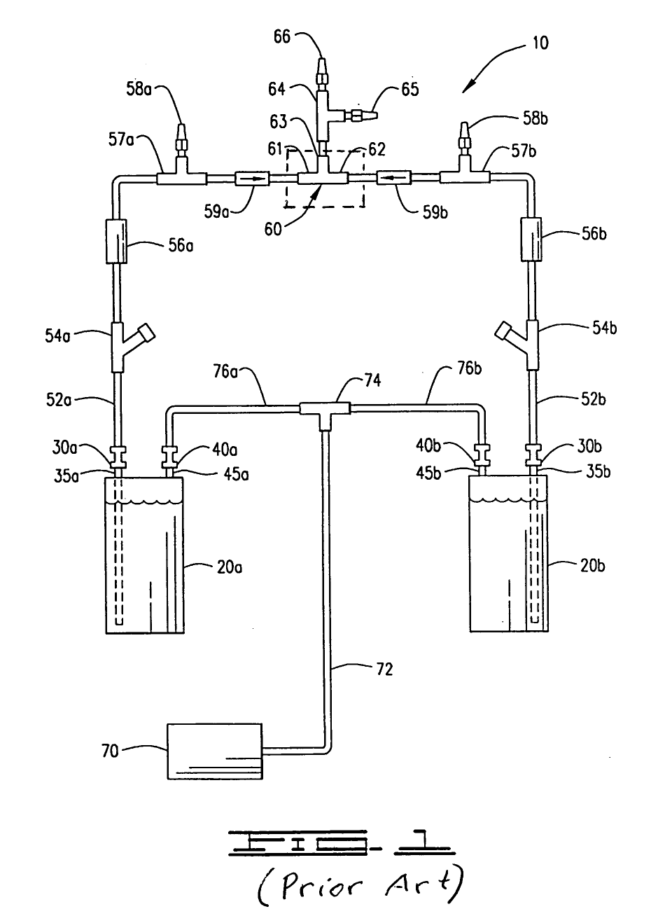

A prior art application device may be used to combine the two component solutions; the inventive component solutions may have their respective degrees of acidity and alkalinity adjusted to that when combined in equal amounts, the result is a generally neutral solution. One such prior art application device is shown in FIG. 1. Briefly, the schematic shows two tanks 20a, 20b, each holding a component solution under pressure provided by compressor 70 through lines 72, 76a, and 76b. The solution in tank 20a exits the tank 20a through liquid outlet valve 35a, liquid disconnect 30a, main feed line 52a, filter 54a, inline heater 56a (optional), tee 57a and check valve 59a for delivery to port 61 of the mixing means (in this case, a tee 60). Similarly, the solution in tank 20b exits the tank 20b through liquid outlet valve 35b, liquid disconnect 30b, main feed line 52b, filter 54b, inline heater 56b (optional), tee 57b and check valve 59b for delivery to port 62 of the mixing means. The solutions are combined in equal amounts within tee 60 and exit port 63 of tee 60. Tees 57a, 57b have barbs 58a, 58b to allow another operator to tap into the delivery line to separately receive the contents of tank 20a and 20b, respectively. Compression tee 64 attached to outlet port 63 of the mixing means allows two operators to separately receive the mixed contents of tanks 20a and 20b.

Using a cleaning solution application device such as that shown in FIG. 1, it may be easily seen that if tank 20a contained an alkaline pre-spray solution, then an operator may attach a standard spraying wand and pre-treat areas of textile fabrics that may be heavily soiled with dirt, grease, or oils. It is believed that such treatment may be effective because of chemical action through a saponification process, in which water-soluble soaps may be produced by neutralization of fatty acid soils by the alkaline pre-spray solution. Physical cleaning may also occur via standard welting processes. Similarly, if tank 20b contained an acidic pre-spray solution, then an operator may attach a standard spraying wand to barb 58b and pre-treat areas of textile fabrics that may exhibit brown-out conditions. Since such brown-out is believed to result from a buildup of soaps, detergents, surfactants, ammonia, and de-greasers that have not been completely removed, the acidic pre-cleaning composition may work through the chemical action of neutralization and lifting out of these agents.

When such an application device as that described in FIG. 1 is actuated, the solution from both containers may be propelled into opposing ports of the mixing means 60, where the two solutions mix and the process of self-carbonation continues. When the mixing means 60 is a compression tee, then equal amounts of the solution from each container are mixed. The resulting freshly carbonated cleaner may be expelled from the mixing means through port 64 where it may exhibit a pH of approximately 7.

However, with the addition of a quick-connect hose connection in the solution line preceding each check valve of the tee fitting, a solution hose and spray apparatus can be connected to either solution tank independently of the other tank so that a spray containing the solution with a pH of about 10 or a spray containing the solution with a pH of about 4 can be separately accessed without causing the solutions to be mixed together.

When the alkaline pre-cleaning solution described in the example is accessed in this manner, it can be sprayed on a textile fabric that has been deemed to be heavily soiled or even damaged by contaminates. This may eliminate the need for a more conventional or additional pre-spray that may generally use undesirable ingredients, such as soaps, detergents, surfactants, solvents or ammonia. The alkaline pre-cleaning solution may remain on the textile fabric long enough to break down and emulsify the heavy soils. It may then be cleaned out of the textile fabric, along with the soils and contaminates, by using a lower pH self-carbonated solution in the other container, the self-carbonating cleaning solution made by mixing the two solutions through the tee fitting, or by any other desired cleaner and method, as long as sufficient cleaning takes place to render the pH of the cleaner in the textile fabric at or about 7.

When the acidic pre-cleaning solution described in the example is accessed in this manner, it can be sprayed on a textile fabric exhibiting brown-out characteristics as described heretofore. This may eliminate the need for a more conventional and additional pre-spray that generally uses acids or acids that are buffered with soaps, detergents, surfactants, and solvents. The solution may be allowed to remain on the fabric long enough to reverse the browning effect of the concentrated residue. It may then be cleaned out of the textile fabric, along with the soils and contaminates, by using the higher pH carbonated solution in the other container, the self-carbonating cleaning solution made by mixing the two solutions through the mixing means, or by any other cleaner and method desired as long as sufficient cleaning takes place to render the pH of the cleaner in the carpet at or about 7.

Unlike some prior art cleaning compositions, the compositions provided by the invention do not require heating, although heating may be used if desired. There are a few advantages but many disadvantages to applying a heated cleaning solution to textile fabrics as a general practice. Because the two solutions described herein may not contain any soaps, detergents, surfactants, ammonia, or other potentially harmful chemicals, and because of the efficiency of the application device, the cleaner and its subsequent components may be applied in relatively small amounts to accomplish proper cleaning. Thus, the cleaner and subsequent components of the cleaner that are provided by the invention can easily be heated and the temperatures regulated in a safe, economical, and efficient manner.

The cleaning solution and process described heretofore have led to the discovery and development of additional new and unique products for the cleaning industry. One product uses a weak natural acid as a naturalizing agent that has a low pH, but not so low that it will damage textile fiber, carpet fiber, dyestuff, or factory applied protectants. The acid may be buffered with a carbonate salt and a bicarbonate or percarbonate salt, rather than with soaps, detergents, surfactants of any other alkaline products commonly thought to be the basis of a cleaning agent.

When used in such an application device, a self-carbonating cleaning composition may be provided by a combination of two separate, partially-carbonated solutions, where one solution is acidic and one is alkaline. For example, one tank 20a may contain an acidic aqueous solution, comprising by volume between 30 and 50 ml of a bicarbonate or percarbonate salt (preferably about 41.6 ml), between 10 and 30 ml of a carbonate salt (preferably about 20.9 ml), and between 300 and 325 ml of a natural solid acid (preferably about 312.5 ml). This solution may be provided with sufficient water so that it may have a pH of about 4. When the solid acid, carbonate salt, and bicarbonate or percarbonate salt are mixed, the resulting acidic aqueous solution may exhibit a mild effervescing action. The acidic aqueous solution may contain sufficient carbonate and bicarbonate salts and natural solid acid to assure that these constituents will be completely dissolved and buffered; however, the resulting acidic aqueous solution provides a large concentration of remaining acid to serve as a reactant with alkaline-based contaminates embedded in the textile fibers. The alkaline effect of the salts in solution does not interfere with the reactive ability of the acid, nor does it add to the problem of alkaline-based products in the textile fiber.

A second tank 20b may contain an alkaline aqueous solution containing by volume between 190 and 220 ml of a bicarbonate or percarbonate salt (preferably about 208.4 ml), between 90 and 120 ml of a carbonate salt (preferably about 104.1 ml), and between 50 and 70 ml of a natural solid acid (preferably about 62.5 ml). This solution may be provided with sufficient water so that it may have a pH of about 10 and may contain sufficient carbonate/bicarbonate/percarbonate salts and natural solid acid to insure that the constituents will be completely dissolved and buffered.

However, the two solutions previously described may be chemically unbalanced so that, upon being combined and mixed in equal quantities, their combination results in a self-carbonating cleaning solution having an essentially neutral pH and a solids concentration between about 1.0% to 5% by volume (1.5% to 4% by weight). A large concentration of acid may be left un-neutralized in one solution in tank 20a, and a large concentration of the carbonate/bicarbonate/percarbonate salts may be left un-neutralized in the second solution in tank 20b, which combine to provide the effervescing action in the self-carbonated cleaning solution.

The acidic aqueous solution may be separately applied as an acidic partially-carbonated pre-spray solution to a textile fabric that has been deemed damaged by soapy and alkaline residues. It may be left on the textile fabric for a period of time sufficient to reverse the browning effect of the concentrated residues. It may then be cleaned out of the textile fabric, along with the soils and contaminates, by either using a higher pH self-carbonating solution, a self-carbonating cleaning solution described in the prior art, or any other appropriate cleaning method, so long as sufficient cleaning takes place to render the pH of the self-carbonating cleaning solution, described in the application, at or about 7. The solution may optionally be heated according to the conditions which may prevail at the time of application.

The alkaline aqueous solution described in the example may preferably contain sodium bicarbonate as the bicarbonate or percarbonate salt, sodium carbonate as the carbonate salt, and citric acid as the solid acid. When mixed, the resulting alkaline aqueous solution will be mildly carbonated, exhibit a mild effervescing action, and it may have a pH of about 10. The solution may contain enough carbonate salts and natural solid acid to assure that the constituents will be completely dissolved and buffered, but are chemically out of balance so that there is a large concentration of carbonates left as a reactant with the contaminants embedded in the carpet fibers. It provides a carbonate/bicarbonate/percarbonate alkaline-based cleaning agent that has a high alkaline pH, but not so high that it will damage carpet fiber, dyestuff, or factory applied protectants. The carbonate salts may be buffered with a weak natural acid and require no soaps, detergents, surfactants, urea, ammonia, or any other alkaline products normally thought to be the basis of a cleaning agent.

The alkaline aqueous solution may then be separately applied as an alkaline partially-carbonated pre-spray solution to a textile fabric that has been deemed damaged by excessive amounts of grease, soils, oils, and fatty residues. It may be allowed to remain on the textile fabric long enough to penetrate and break down all foreign residues. It may then be cleaned out of the textile fabric, along with the soils and contaminants, by using a lower pH self-carbonating solution, a self-carbonating cleaning solution described in the prior art, or any other appropriate cleaning method, so long as sufficient cleaning takes place to render the pH of the self-carbonating cleaning solution described in the application, at or about 7.

Note that the acidic aqueous solution and the alkaline aqueous solution may contain different combinations of acids, carbonates, and bicarbonate or percarbonate salts without departing from the scope of the invention. Furthermore, the selection of an acid, carbonate salt, or bicarbonate or percarbonate salt made for the acidic aqueous solution may be different from the selection of an acid, carbonate salt, or bicarbonate or percarbonate salt made for the alkaline aqueous solution and still be within the scope of the invention. The carbonate salts may be selected from the group consisting of sodium carbonate, lithium carbonate, potassium carbonate, and ammonium carbonate. The bicarbonate or percarbonate salts may be selected from the group consisting of sodium bicarbonate, sodium percarbonate, lithium bicarbonate, lithium percarbonate, potassium bicarbonate, potassium percarbonate, ammonium bicarbonate, and ammonium percarbonate. The acids may be selected from the group consisting of citric acid, succinic acid, tartaric acid, adipic acid, glutaric acid, and oxalic acid.

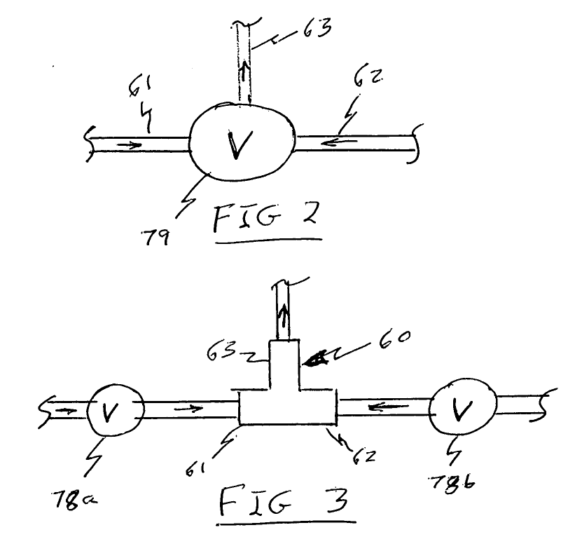

The mixing means provided by the application device in FIG. 1 provides for mixing equal amounts of the component cleaning solutions from tanks 20a and 20b. Another embodiment of the mixing means, as depicted in FIG. 2, may be a valve 79 in place of the compression tee 60. Valve 79 may enable the operator to control the proportion of cleaning solutions in tanks 20a and 20b so that the pH of the resulting mixture may be selectively determined. This determination may be made by knowing the composition and pH of each of the two component cleaning solutions, measuring the pH of the resulting mixture for selected positions of the valve 79, and providing a indicator (not shown) that shows the operator where the point of neutral pH occurs for different combinations of component cleaning solutions. Alternatively, as shown in FIG. 3, separate valves 79a, 79b may be provided for each supply line to the compression tee 60, so that the amount of cleaning solution provided by each tank 20a, 20b may be separately controlled.

As has been demonstrated, the present invention provides an advantageous method, apparatus, and cleaning solution for the cleaning of carpets and fabrics. While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

We claim:

1. A self-carbonating cleaning solution prepared by combining
a. an alkaline solution prepared by mixing a first acid, a first carbonate salt, and a first bicarbonate or percarbonate salt in water, so that the alkaline solution has a pH in the range of 9 to 11, and
b. an acidic solution prepared by mixing a second acid, a second carbonate salt, and a second bicarbonate or percarbonate salt in water, so that the acidic solution has a pH in the range of 3 to 5;
wherein the alkaline solution reacts with the acidic solution to produce the self-carbonating cleaning solution having a pH of between 6 and 8 and carbon dioxide, and wherein the solids concentration in the self-carbonating cleaning solution is between about 1.0% to 5% by volume (1.5% to 4% by weight).

2. The self-carbonating cleaning solution of claim 1, wherein the first carbonate salt is selected from the group consisting of sodium carbonate, lithium carbonate, potassium carbonate, and ammonium carbonate.

3. The self-carbonating cleaning solution of claim 1, wherein the second carbonate salt is selected from the group consisting of sodium carbonate, lithium carbonate, potassium carbonate, and ammonium carbonate.

4. The self-carbonating cleaning solution of claim 1, wherein the first bicarbonate or percarbonate salt is selected from the group consisting of sodium bicarbonate, sodium percarbonate, lithium bicarbonate, lithium percarbonate, potassium bicarbonate, potassium percarbonate, ammonium bicarbonate, and ammonium percarbonate.

5. The self-carbonating cleaning solution of claim 1, wherein the second bicarbonate or percarbonate salt is selected from the group consisting of sodium bicarbonate, sodium percarbonate, lithium bicarbonate, lithium percarbonate, potassium bicarbonate, potassium percarbonate, ammonium bicarbonate, and ammonium percarbonate.

6. The self-carbonating cleaning solution of claim 1, wherein the first acid is selected from a group consisting of citric acid, succinic acid, tartaric acid, adipic acid, glutaric acid, and oxalic acid.

7. The self-carbonating cleaning solution of claim 1, wherein the second acid is selected from a group consisting of citric acid, succinic acid, tartaric acid, adipic acid, glutaric acid, and oxalic acid.

8. The self-carbonating cleaning solution of claim 1, wherein the first and second carbonates are sodium carbonate, the first bicarbonate or percarbonate is sodium bicarbonate, the second bicarbonate or percarbonate is sodium bicarbonate, and the first and second acids are citric acid.

9. The self-carbonating cleaning solution of claim 1, wherein the acidic solution is an acidic partially-carbonated pre-spray solution that is prepared by mixing by volume about 10 to 30 ml of the first carbonate salt, about 30 to 50 ml of the first bicarbonate or percarbonate salt, and about 300 to 325 ml of the first acid, so that the acidic solution has a pH of about 4, whereby the acidic solution may be used separately for either pre-treatment of heavily soiled textile fibers or for a component of the self-carbonating cleaning solution.

10. The self-carbonating cleaning solution of claim 9, wherein the first carbonate salt is 20.9 ml of sodium carbonate, the first bicarbonate or percarbonate salt is 41.6 ml of sodium bicarbonate, and the first acid is 312.5 ml of citric acid.

11. The self-carbonating cleaning solution of claim 1, wherein the alkaline solution is an alkaline partially-carbonated pre-spray solution that is prepared by mixing by volume about 90 to 120 ml of the second carbonate salt, about 190 to 220 ml of the second bicarbonate or percarbonate salt, and about 50 to 70 ml of the second acid, so that the alkaline solution has a pH of about 10, whereby the alkaline solution may be used separately for either pre-treatment of heavily soiled textile fibers or for a component of the self-carbonating cleaning solution.

12. The self-carbonating cleaning solution of claim 11, wherein the second carbonate is about 104.1 ml of sodium carbonate, the second bicarbonate or percarbonate is 208.4 ml of sodium bicarbonate, and the second acid is 62.5 ml of citric acid.

13. A method of cleaning textile fibers using an application device having a first removable tank and a second removable tank, the method comprising
a. providing an alkaline partially-carbonated pre-spray solution having a pH of about 10 in the first removable tank;
b. providing an acidic partially-carbonated pre-spray solution having a pH of about 4 in the second removable tank;
c. selectively pre-treating portions of the textile fibers with the acidic partially-carbonated pre-spray solution;
d. selectively pre-treating portions of the textile fibers with the alkaline partially-carbonated pre-spray solution;
e. combining the alkaline partially-carbonated pre-spray solution in the first removable tank and the acidic partially-carbonated pre-spray solution in the second removable tank through use of a mixing means associated with the application device to provide a self-carbonated cleaning solution having a pH in a range between 6 and 8; and
f. cleaning the textile fibers with the self-carbonated cleaning solution;
wherein the removable tanks remain on the device and are not replaced with removable tanks containing different pre-spray solutions.

14. The method according to claim 13, wherein alkaline partially-carbonated pre-spray solution is a mixture by volume of about 90 to 120 ml of a carbonate salt, about 190 to 220 ml of a bicarbonate or percarbonate salt, and about 50 to 70 ml of an acid, in solution with a sufficient amount of water so that the mixture has a pH of about 10.

15. The method according to claim 13, wherein acidic partially-carbonated pre-spray solution is a mixture by volume about 10 to 30 ml of a carbonate salt, about 30 to 50 ml of a bicarbonate or percarbonate salt, and about 300 to 325 ml of an acid, in solution with a sufficient amount of water so that so that the mixture has a pH of about 4.

16. The method according to claim 13, wherein the mixing means is a compression tee fitting that combines equal portions of the alkaline partially-carbonated pre-spray solution and the acidic partially-carbonated pre-spray solution.

17. The method according to claim 13, wherein the mixing means is a valve that combines selected ratio of the alkaline partially-carbonated pre-spray solution and the acidic partially-carbonated pre-spray solution.

18. The method according to claim 13, wherein the mixing means is a first valve controlling the alkaline partially-carbonated pre-spray solution and a second valve controlling the acidic partially-carbonated pre-spray solution, wherein the amounts of each pre-spray solution combining to provide the self-carbonated cleaning solution are separately selectable.

19. A system for cleaning textile fibers comprising
a. an application device having a first removable tank containing an alkaline partially-carbonated pre-spray solution having a pH of about 10 and a second removable tank containing an acidic partially-carbonated pre-spray solution having a pH of about 4;
b. a means for delivering the alkaline partially-carbonated pre-spray solution for pre-treatment of a first selected area of textile fibers;
c. a means for delivering the acidic partially-carbonated pre-spray solution for pre-treatment of a second selected area of textile fibers; and
d. a mixing means for proportionately combining the contents of the tanks to provide a self-carbonated cleaning solution.

20. The system described in claim 19, wherein the mixing means is a compression tee fitting that combines equal portions of the alkaline partially-carbonated pre-spray solution and the acidic partially-carbonated pre-spray solution.

21. The system described in claim 19, wherein the mixing means is a valve that combines selected ratio of the alkaline partially-carbonated pre-spray solution and the acidic partially-carbonated pre-spray solution.

22. The system described in claim 19, wherein the mixing means is a first valve controlling the amount of the alkaline partially-carbonated pre-spray solution provided to a first port of a compression tee and a second valve controlling the amount of acidic partially-carbonated pre-spray solution provided to a second port of the compression tee, the compression tee providing a mixture of the pre-spray solutions through a third port, wherein the amounts of each pre-spray solution combining to provide the self-carbonated cleaning solution are separately selectable.
